(19) United States
(12) Patent Application Publication
(10) Pub. No.: US 2022/0112750 A1
(43) Pub. Date: Apr. 14, 2022

(54) Detachable and Reversible Cooler Lid Hinge Assembly

(71) Applicants: Spencer Sutlive, Duluth, GA (US); Joseph Pruitt, Athens, GA (US)

(72) Inventors: Spencer Sutlive, Duluth, GA (US); Joseph Pruitt, Athens, GA (US)

(21) Appl. No.: 17/327,624

(22) Filed: May 21, 2021

(51) Int. Cl. E05D 7/12; E05D 5/06; E05D 9/00; F25D 3/08

(52) U.S. Cl. CPC E05D 7/12; E05D 5/06; E05D 9/005; E05Y 2900/602; E05D 2007/128; E05Y 2600/502; F25D 3/08

(57) ABSTRACT

The invention consists of a novel cooler hinge construction that allows for the cooler's lid to be removed and reattached easily. One benefit of such an assembly is that either side of the lid may be used facing upwards, depending on what the user is doing at the time. The lid is attached to the hinge by a clamp assembly that pinches the lid and holds it in place. The jaws of the clamp are housed within identical grooves on the top and bottom of the lid, allowing the lid to be pulled out of the clamp when the cooler is open and to be subsequently reattached by sliding the lid back into the clamp. This functionality allows for the lid to be removed and reattached easily, but also holds it securely in place when the cooler is closed because the lid is unable to move laterally. The clamp also serves as a controlled fail point for the invention, allowing the lid to break away before the hinge or clamp are damaged.

### CROSS-REFERENCE TO OTHER APPLICATIONS

This application does not claim the benefit of any other application.

### BACKGROUND OF THE INVENTION

The invention consists of a novel hinge assembly for use in portable coolers. Portable coolers are insulated cavities used to keep items cold. Oftentimes, the coolers are used along with ice or some other cold emitting substance in order to cool items down and keep them cold. Accordingly, insulation has long been seen as the critical function of the cooler, with other features playing a less important role. Coolers made of cloth, some bearing zippers, even some with speakers have been created in the decades since the product rose to prominence. They have come in many shapes and sizes, but the lid has essentially remained unchanged in every iteration to date.

In order to provide insulations, coolers need to be shut off from the outside environment. An open top results in a large amount of heat exchange, so most coolers include a lid to cover the cooler when people are not taking things in or out of it. To keep the lid from going missing, these lids are usually attached via a hinge or some kind of equivalent structure that binds the lid to the body of the cooler while allowing it to swing open. Coolers that do not include some sort of hinge can see their tops jostle off when not properly secured, and many times the lids end up lost after falling off one too many times.

Traditionally, the hinge of a cooler system is fixed to the body as well as to the lid, resulting in limited functionality in a number of ways. Lids fixed in this way effectively block access to the cooler from the side that bears the hinge when the cooler is open. Only one side of the lid can bear useful features, such as cup holders or rulers, rendering the bottom of the lid virtually useless. These fixed hinge systems are often the most structurally vulnerable portion of a cooler, and therefore the most likely to break under strenuous use. The present invention seeks to remedy these issues by altering the design of the hinge lid to include a clamp. This modification allows the lid to break away from the hinge and be reattached, even when flipped upside down. If the lid is removed entirely, it may be used as a tray while the cooler is accessible from every side.

### BRIEF SUMMARY OF THE INVENTION

The present invention comprises a hinge attached to a clamp that is used in concert with a detachable and reversible lid. The invention provides numerous benefits over conventional cooler hinge systems. The removal of the lid facilitates easier access to the cooler, use of either side of the lid, and easy replacement of a lid with some other compatible variant. Grooves on one side of the lid are sized to match the clamps, whether facing upwards or downwards, meaning that the lid can be reattached in more than one configuration depending on the current activity. In addition, the use of a detachable lid held on by a clamp creates a controlled fail point, allowing the lid to separate instead of tearing or otherwise damaging the hinge itself

The bottom portion of the hinge is mounted to the cooler body, but the upper portion of the hinge is attached to a clamp instead of being attached directly to the lid itself. The lid, with grooves designed to match the clamp, can then be attached or removed as long as the cooler is open. If the cooler is closed, a latch holds the side of the lid opposite the hinge down and the clamps are incapable of sliding off the lid. If the cooler is open, the lid can be removed with a small amount of force, reversed, and slid back into the clamps. Should the lid be subjected to force, say from the movement of a boat or vehicle, while it is open, it can break away without causing harm to the hinge assembly, the body of the cooler, or the lid.

### BRIEF DESCRIPTION OF THE DRAWINGS

FIG. 1 shows a rear view of the hinge construction, inclusive of the body of the cooler. A hinge plate is attached directly to the body of the cooler, and the clamp is connected to the plate in a fashion that allows it to rotate. In this embodiment, two hinge and clamp assemblies are used to secure the lid, which is shown in the closed position. It is clear from the figure how the lid would be removed in the open configuration by pulling it from the jaws of the clamp, but also how the lid is held in place by the opposite side of the cooler body when the lid is mounted in the closed position.

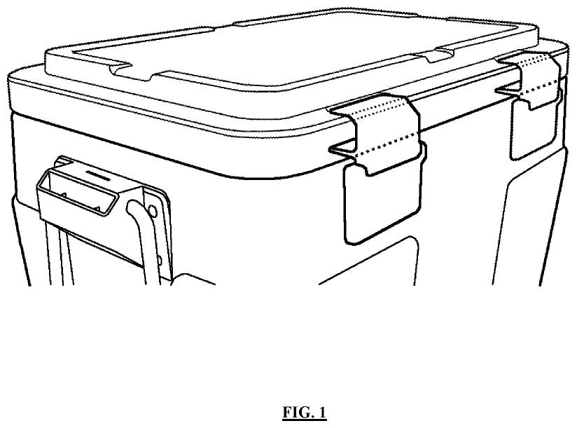

FIG. 2 shows the clamp as it is mounted into the grooves on the lid. The top and bottom jaws of the clamp are pressed against the grooves in the top and bottom of the lid designed to accommodate them. The lid is shown via dotted lines between the jaws of the clamp. While the invention works best with these grooves in place, it could still function without them due to pressure applied by the clamp, which is slightly smaller than the lid in order to hold it snuggly in place when the lid is attached. The clamp is shown mounted to the base of a hinge by a pin, allowing it to rotate.

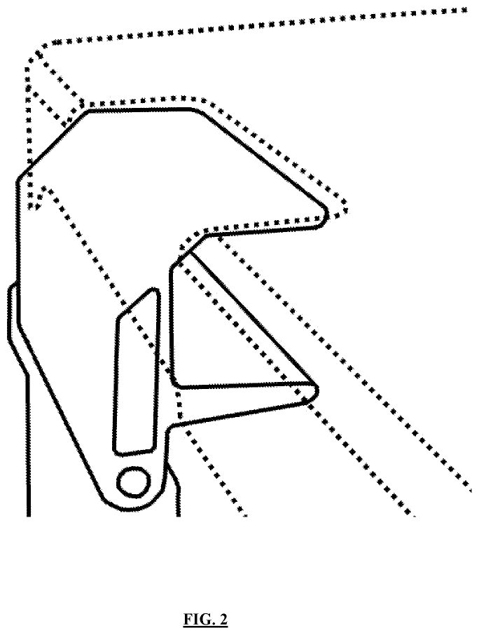

FIG. 3. shows the clamp and lid in the open configuration with the lid detached. The circular arrow depicts the fashion in which the lid may be rotated before being reattached to the clamp. This rotation allows access to either surface of the lid. The small straight arrow shows the fashion in which the lid is pressed back into the clamp, which would result in the lid being reattached after being rotated.

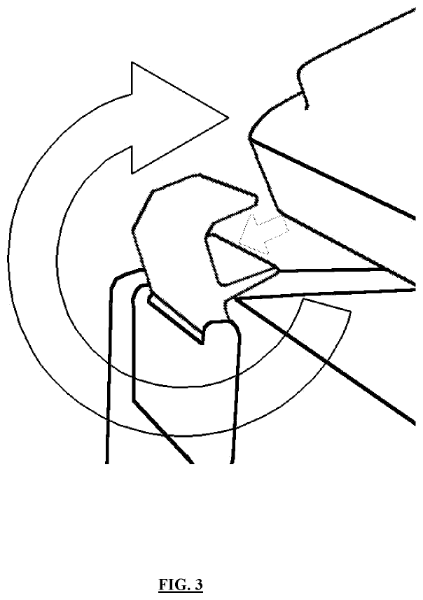

### DETAILED DESCRIPTION

The following description will include references to specific structural embodiments and methods. It is to be understood that there is no intention to limit the invention to the specifically disclosed embodiments and methods, but the invention may be practiced using other features, elements, methods, and embodiments. Preferred embodiments are described to illustrate the present invention, not to limit its scope. Several different equivalents exist for many of the mechanisms used in the invention. Specific embodiments are given to provide examples, however embodiments which incorporate materials with properties similar to those noted in the materials chosen should also be considered. Those of ordinary skill in the art will recognize a variety of equivalent variations on the description that follows.

The cooler body and lid are constructed from a rigid or semi rigid material coating a layer of insulation in order to provide the overall structure. The hinges, as well as any handles or latches, are attached to the cooler by screws, fasteners, or glue. In some variations, straps are used to hug the cooler as an alternative, especially when the material from which the cooler is constructed would not serve as an effective anchor point. Hinges are used to fix the lid in place and allow it to be opened and closed by lifting the lid from the side opposite the hinges.

The lid is attached to the hinge assembly by one or more clamps. In one embodiment, two clamps are used to increase stability. The clamp may be designed to fit within grooves on the lid to prevent them from sliding laterally. To remove the lid, the cooler must be in the open configuration. Once opened, the lid can be removed by pulling it from the jaws of the clamp. The clamp is designed such that a small amount of force in the proper direction allows for the removal of the lid, with roughly the same amount of force being necessary to place the lid back within the clamp jaws if applied in the opposite direction. This functionality allows for the lid to be removed and reattached with ease.

Various useful or ornamental features may be included on either side of the lid. These features may include, but are not limited to, a means for making measurements, cutting surfaces, cup holders, instructions, maps, and decorations. When the lid is removed from the clamp or clamps, it can be easily flipped upside down to provide access to a second set of features before being reattached. Being able to use either side of the lid effectively doubles the amount of usable space on the top of a cooler in terms of the number of functional elements that can be included in the design. In one embodiment, multiple lids which fit the clamps can be used to provide even further benefits and diversity in terms of functionality.

When a cooler is left open, the hinges are vulnerable to damage. Hinges are usually the only moving parts present on a cooler and may be made or brittle materials like plastic or bendable materials like metal. Regardless of the material, damage to hinges is a risk when the cooler is open. If hinges break or bend, it may be difficult or impossible to close the cooler, which results in heat loss which in turn renders the item useless. If the hinges hold, then the cooler may be flipped backward, and its contents scattered. The present invention remedies this concern by including a controlled fail point. If held in place by clamps, any significant force will cause the lid to be removed from the hinge assembly before the hinge itself is damaged or the cooler is flipped over. While the lid is kicked loose in the process, it can be easily retrieved and reattached, ultimately preventing damage to the overall function of the cooler.

The current invention presents numerous long awaited benefits. Using a clamp hinge to fix a detachable lid prevents destruction of the hinge assembly during strenuous use, allows for reversal and use of multiple sides of a single lid, allows for easy substitution of multiple lids, and allows for access of the cooler from any angle when the lid is removed. These benefits provide a significant improvement to the use of coolers in both sporting and leisure activities and alleviate some of the age-old issues when it comes to the use of coolers in either context.

1. A hinge construction for the lid of a portable cooler comprising:
a hinge affixed to the body of a cooler; and
a clamp made of hard plastic attached to the hinge, said clamp having a top and a bottom jaw; and
a lid that includes two usable sides; and
grooves on a portion of the lid sized to accommodate the clamp jaws.

2. The hinge construction of claim 1, where the jaws of the clamp flex around grooves in the rigid lid to hold it in place.

3. The hinge construction of claim 1, where the clamp serves as a controlled fail point that releases the lid under less force than is necessary to damage the hinge.

4. The hinge construction of claim 1, further comprising a cooler body affixed to the hinge that is designed to fit the lid and hold it in place.

5. The hinge construction of claim 4, further comprising a latching mechanism attached to the opposite side of the cooler body in order to hold the lid to the body when closed.

6. A hinge system for use in portable coolers comprising:
a lid; and
a clamping device; and
a hinge attached to the clamping device; and
impressions within the lid which fit the clamping device.

7. The hinge system of claim 6, where the clamping device is made of plastic.

8. The hinge system of claim 6, where the clamping device is able to attach to the lid in more than one configuration.

9. The hinge system of claim 6, where the lid further comprises a top side and a bottom side.

10. The hinge system of claim 6, where either the top side or the bottom side of the lid may be fixed into the clamping device such that it faces outward when the cooler is closed.
